(19) United States
(12) Patent Application Publication
(10) Pub. No.: US 2022/0114587 A1
(43) Pub. Date: Apr. 14, 2022

(54) DEVICE BINDING/DEVICE REGISTRATION FOR IOT DEVICES

(71) Applicant: Wells Fargo Bank, N.A., San Francisco, CA (US)

(72) Inventors: Ashish B. Kurani, Burlingame, CA (US); Miranda Hill, Seattle, WA (US); Caroline Machado, Mountain View, CA (US)

(21) Appl. No.: 14/881,709

(22) Filed: Oct. 13, 2015

(51) Int. Cl. G06Q 20/40; G06Q 20/32

(52) U.S. Cl. CPC G06Q 20/405; G06Q 20/322

(57) ABSTRACT

A computer-implemented method of facilitating payments from a device includes binding the device with a device payment account. Binding includes establishing operative communication between a hub of a local network and the device, transmitting a device identifier to the device, and creating a device profile for the device. The device profile includes spending controls and a duplicate device identifier. A payment request is received from the device. The payment request includes a payment request indicator and the device identifier. The device is authenticated if the device identifier received with the payment request matches the duplicate device identifier. Upon authenticating the device, payment parameters are determined based on the payment request. It is verified that the payment parameters do not violate the spending controls. Upon verifying that the payment parameters do not violate the spending controls, a payment is transmitted to a recipient based on the payment parameters.

### BACKGROUND

The present disclosure relates generally to the field of payment systems. More specifically, the present disclosure relates to systems and methods for device binding and device registration for devices that are configured to make payments.

As broadband Internet connectivity has become nearly ubiquitous, individuals increasingly rely on Internet-based tools to conduct their daily activities more efficiently and effectively. For example, an individual may manage various financial accounts and facilitate payments for goods and services via Internet-based tools rather than having to visit brick-and-mortar establishments (e.g., banks and merchants). Additionally, low-cost processors and sensors have made devices (e.g., appliances) “smart,” such that the devices may collect operational data to improve their efficiency and reliability. Further, such devices in the physical world are becoming increasingly interconnected through the Internet by way of various data communications standards, such as Bluetooth, NFC, Wi-Fi, 3G, etc.

### SUMMARY

According to one example embodiment, a method of facilitating payments from a device includes binding the device with a device payment account. Binding includes establishing operative communication between a hub of a local network and the device. Binding also includes transmitting a device identifier to the device. The device identifier uniquely identifies the device in the computer system. Binding further includes creating a device profile for the device. The device profile includes spending controls for the device and a duplicate device identifier. The duplicate device identifier matches the device identifier transmitted to the device. The device profile is stored in a database of the computer system. A payment request is received from the device. The payment request includes a payment request indicator and the device identifier. The device is authenticated if the device identifier received with the payment request matches the duplicate device identifier stored in the device profile. Upon authenticating the device, payment parameters are determined based on the payment request. It is verified that the payment parameters do not violate the spending controls stored in the device profile. Upon verifying that the payment parameters do not violate the spending controls, a payment is transmitted to a recipient based on the payment parameters.

According to another example embodiment, a system includes a server system including a processor and instructions stored in non-transitory machine-readable media. The instructions are configured to cause the server system to bind the device with a device payment account. To bind the device, operative communication between the device and the server system via a hub of a local network is established. A device identifier is transmitted to the device. The device identifier uniquely identifies the device in the server system. A device profile is created for the device. The device profile includes spending controls for the device and a duplicate device identifier. The duplicate device identifier matches the device identifier transmitted to the device. The device profile is stored in a database of the server system. Next, a payment request is received from the device. The payment request includes a payment request indicator and the device identifier. In addition, the device is authenticated if the device identifier received with the payment request matches the duplicate device identifier stored in the device profile. Further, upon authenticating the device, payment parameters are determined based on the payment request. Still further, it is verified that the payment parameters do not violate the spending controls stored in the device profile. Further yet, upon verifying that the payment parameters do not violate the spending controls, a payment is transmitted to a recipient based on the payment parameters.

According to one example embodiment, a method of facilitating payments from a device includes binding the device with a device payment account. Binding includes establishing operative communication between the device and a computer system. Binding also includes transmitting a device identifier to the device. The device identifier uniquely identifies the device in the computer system. Binding further includes creating a device profile for the device. The device profile includes spending controls for the device and a duplicate device identifier. The duplicate device identifier matches the device identifier transmitted to the device. The device profile is stored in a database of the computer system. A payment request is received from the device. The payment request includes a payment request indicator and the device identifier. The device is authenticated if the device identifier received with the payment request matches the duplicate device identifier stored in the device profile. Upon authenticating the device, payment parameters are determined based on the payment request. It is verified that the payment parameters do not violate the spending controls stored in the device profile. Upon verifying that the payment parameters do not violate the spending controls, a payment is transmitted to a recipient based on the payment parameters.

According to another example embodiment, a system includes a server system including a processor and instructions stored in non-transitory machine-readable media. The instructions are configured to cause the server system to bind the device with a device payment account. To bind the device, operative communication between the device and the server system is established. A device identifier is transmitted to the device. The device identifier uniquely identifies the device in the server system. A device profile is created for the device. The device profile includes spending controls for the device and a duplicate device identifier. The duplicate device identifier matches the device identifier transmitted to the device. The device profile is stored in a database of the server system. Next, a payment request is received from the device. The payment request includes a payment request indicator and the device identifier. In addition, the device is authenticated if the device identifier received with the payment request matches the duplicate device identifier stored in the device profile. Further, upon authenticating the device, payment parameters are determined based on the payment request. Still further, it is verified that the payment parameters do not violate the spending controls stored in the device profile. Further yet, upon verifying that the payment parameters do not violate the spending controls, a payment is transmitted to a recipient based on the payment parameters.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims.

FIG. 1 is a block diagram illustrating a data processing system, according to an embodiment.

FIG. 2 illustrates block diagrams of the client device and the device payment system of FIG. 1.

FIG. 3 is a flow diagram of a method of facilitating payments from a device, according to an embodiment.

FIG. 4 is a flow diagram of performing transactions, according to an embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

Referring generally to the figures, systems and methods for device registration and device binding for internet of things (IoT) systems are described. According to various embodiments, the systems and methods provide a secure platform for operating and managing internet-enabled (e.g., IoT) devices that are capable of making or initiating payments.

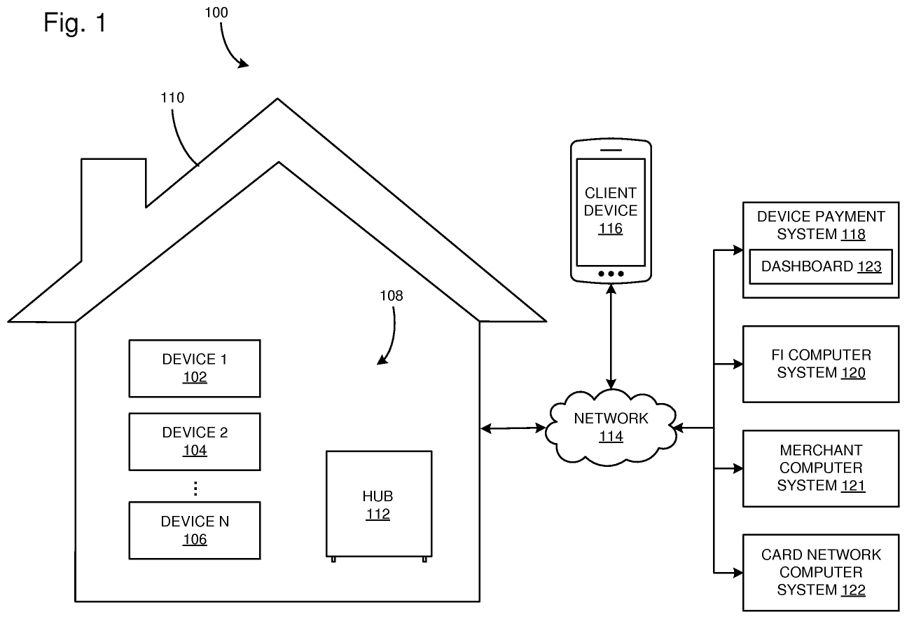

FIG. 1 is a block diagram illustrating a data processing system 100, according to an embodiment. As illustrated in FIG. 1, the data processing system 100 includes various devices, including a first device 102, a second device 104, and so on, up to an Nth device 106. The devices 102, 104, 106 are shown in FIG. 1 as being in communication with a local network 108, such as a home area network (“HAN”) or a local ad-hoc network, which may be located within a connected home 110. The devices 102, 104, 106 may be conceptualized as nodes within the local network 108. The local network 108 may also include a hub 112. The hub 112 may be structured to facilitate communication between the devices 102, 104, 106 and an external network 114, which may include one or more of the Internet, cellular network, Wi-Fi, Wi-Max, a proprietary banking network, or any other type of wired or wireless network. The local network 108 may be conceptualized as an “Internet of Things” (IoT) network, with the devices 102, 104, 106 and the hub 112 being “things” within the IoT network. In operation, the local network 108 may include any number of “things” of various different types.

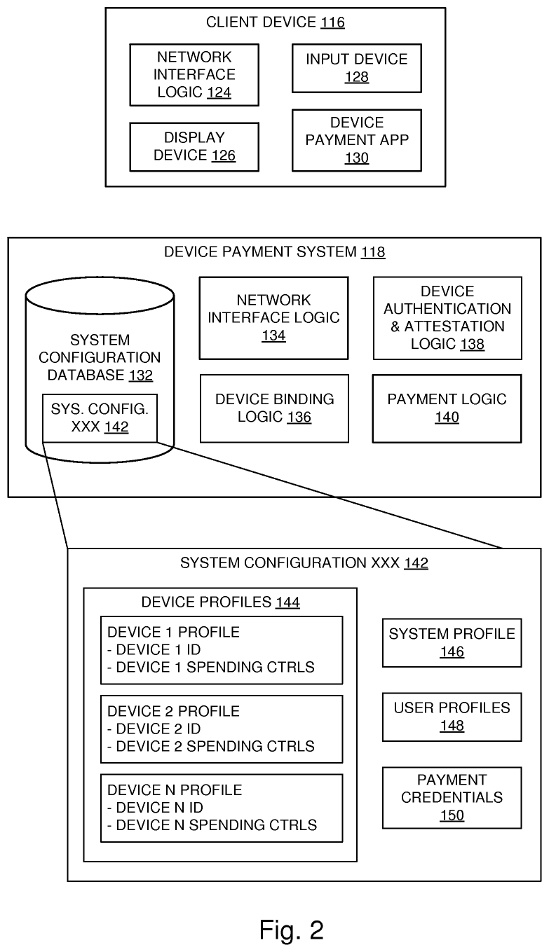

The data processing system 100 also includes a client device 116, a device payment system 118, an FI computer system 120, a merchant computer system 121, and a card network computer system 122. The various systems and devices may communicate through the external network 114. In some embodiments, the device payment system 118 and the FI computer system 120 may be owned by the same entity. In other embodiments, the device payment system 118 and the FI computer system 120 may be owned by different entities. The device payment system 118 includes a dashboard 123, which a user can access to control various aspects of the device payment system 118. Individual users may access the dashboard 123 via the client device 116 or via other devices. The client device 116 is described in further detail below in connection with FIG. 2.

The devices 102, 104, 106 may be any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. The devices 102, 104, 106 may have a passive communication interface, such as a quick response (QR) code, a radio-frequency identification (RFID) tag, an NFC tag, etc., or an active communication interface, such as a modem, a transceiver, etc. The devices 102, 104, 106 can have a particular set of attributes (e.g., a device state or status, such as whether the device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, application specific integrated circuit (ASIC), etc., and configured for connection to the local network 108 (e.g., a local HAN or ad-hoc network), or to the external network 114 (e.g., the Internet).

In one example embodiment, the device 102 includes a sensor configured to detect an operation parameter (e.g., operational state, voltage, current, temperature, acceleration, position, etc.). The device 102 also includes a measurement circuit having a processor and memory. The measurement circuit is in operative communication with the sensor. The measurement circuit is structured to receive a measurement signal relating to the operation parameter, and to interpret an operation parameter value based on the measurement signal. The device 102 also includes a network interface circuit in operative communication with the measurement circuit. The network interface circuit is structured to transmit, to another device, a signal relating to the attribute.

In another example embodiment, the device 102 further includes a control circuit having a processor and memory. The control circuit is in operative communication with the measurement circuit. The control signal is structured to generate a control signal based on the operation parameter value. In one example embodiment, the device 102 further includes an actuator. The actuator may be an electrical, mechanical, virtual, or other type of actuator. The control circuit is further configured to transmit the control signal to the actuator so as to cause the actuator to perform a function.

According to various example embodiments, the devices 102, 104, 106 may include, but are not limited to, lighting systems, thermostats, home theater systems, stereos, televisions, refrigerators, toasters, ovens, microwaves, freezers, dishwashers, dishes, hand tools, clothes washers, clothes dryers, clothing, furnaces, air conditioners, vacuum cleaners, sprinklers, electricity meters, gas meters, etc., so long as the devices are equipped with an addressable communications interface for communicating with the local network 108. The devices 102, 104, 106 may also include smart phones, cellular phones, desktop computers, laptop computers, tablet computers, personal digital assistants (PDAs), etc.

As will be appreciated, the level of functionality that resides on the hub 112 as opposed to the devices 102, 104, 106 may vary depending on the implementation. In one embodiment, the hub 112 is “smart” and one or more of the devices 102, 104, 106 are “constrained” (which may be colloquially referred to as “dumb”). In another embodiment, the hub 112 is constrained and the one or more of the devices 102, 104, 106 are smart. For the purposes of this disclosure, the term “smart” is used to refer to objects that include processing circuitry and memory configured to control payment functionality as described herein. In contrast, the term “constrained” is used to refer to objects that do not include such processing circuitry and memory.

The hub 112 may be a standalone hardware device, or may include a device payment hub application running on a multi-use hardware device. Furthermore, any of the devices 102, 104, 106 may operate as the hub 112. The hub 112 may be any device capable of transmitting information to one or more other devices over a wired or wireless connection. For example, the hub 112 may be a thermostat, a smart TV, a computer or server, a lighting control system, a home entertainment system, a security system, a domestic robot, etc. The device payment hub app or device payment hub circuit may include program logic executable by the hub 112 to implement at least some of the functions described herein. In order to make the device payment hub circuit, the device payment system 118 may provide a software application and make the software application available to be placed on the hub 112. For example, the device payment system 118 may make the software application available to be downloaded (e.g., via the online banking website of the FI, via an app store, or in another manner). Responsive to a user selection of an appropriate link, the device payment hub app may be transmitted to the hub 112 and may cause itself to be installed on the hub 112. Installation of the software application creates the device payment hub circuit on the hub 112. Specifically, after installation, the thus-modified hub 112 includes the device payment hub circuit (embodied as a processor and instructions stored in non-transitory memory that are executed by the processor).

The device payment system 118 manages various aspects of the local network 108, including managing payments from the devices within the local network 108 including, for example, each of the devices 102, 104, 106 and the hub 112, and any other devices within the local network 108. In some embodiments, the device payment system 118 may be operated in whole or in part by the FI computer system 120. In some embodiments, certain functionality of the device payment system 118 is performed by the hub 112. In some embodiments, certain functionality of the device payment system 118 is performed by one or more of the devices 102, 104, 106. The device payment system 118 is also described in further detail below in connection with FIG. 2.

The FI computer system 120 is a computing system at a FI that is capable of maintaining customer accounts (e.g., payment card accounts, such as credit card accounts, demand deposit accounts having an associated debit card, stored value card accounts, and so on) and databases of customer information. In the context of the present disclosure, the FI can include commercial or private banks, credit unions, investment brokerages, and so on.

The merchant computer system 121 is a computing system associated with a merchant with which a customer of the financial institution may transact. Examples of merchants include, for example, retailers, wholesalers, marketplace operators, service providers (e.g., loan servicers, cleaning services, transportation providers, digital wallet services, and so on), and so on. In some arrangements, the merchant computer system 121 is used to create and store data relating to customer transactions (e.g., purchases and refunds). In some such arrangements, the merchant computer system 121 can store databases of information relating to customers such as names, shipping addresses, contact information, and so on. Further, the merchant computer system 121 may be able to operate customer loyalty programs (e.g., membership programs, points programs, frequent shopper discounts, and so on).

The card network computer system 122 is a computer system associated with a card network. Examples of card networks include Visa®, MasterCard®, American Express®, Discover®, Diners Club®, etc. In some embodiments, the card network computing system 122 generates tokens for payment cards. The card network computer system 122 performs operations associated with the generation and issuance of payment tokens. The card network computer system 122 also maintains the established mapping of payment tokens-to-PANs in a token database (or token vault). The card network computer system 122 also detokenizes payment tokens during processing of payment transactions to determine actual account numbers.

The device payment system 118, the FI computer system 120, the merchant computer system 121, and the card network computer system 122 may each include a computer system (e.g., one or more servers each with one or more processing circuits), each including a processor and memory. The processors may be implemented as ASICs, one or more field programmable gate arrays (FPGAs), a group of processing components, or other suitable electronic processing components. The memory may be one or more devices (e.g., RAM, ROM, Flash memory, hard disk storage, etc.) for storing data and/or computer code for completing and/or facilitating the various processes described herein. The memory may be or include non-transient volatile memory, non-volatile memory, non-transitory computer storage media. The memory may include data base components, object code components, script components, or any other type of information structure for supporting the various activities and information structures described herein. The memory may be communicably connected to the processor and include computer code or instructions for executing one or more processes described herein. The device payment system 118, the FI computer system 120, the merchant computer system 121, and the card network computer system 122 may each include server-based computer systems, for example, comprising one or more networked computer servers that are programmed to perform the operations described herein. In another example, the device payment system 118, the FI computer system 120, the merchant computer system 121, and the card network computer system 122 may each be implemented as a distributed computer system where each function is spread over multiple computer systems.

In example embodiments, payment tokens may be surrogate values that replace the primary account number (PAN) associated with a payment card, such as a credit card, debit card, stored value card, etc. Payment tokens may pass basic validation rules of an account number. Hence, the payment token for a credit card in many respects “looks like” a real credit card number, but in fact is only a token. As part of the token generation process, steps are taken such that the generated payment token does not have the same value as or conflict with a real PAN (e.g., a real credit card number). Payment tokens may be provisioned to various locations for use in various types of payment scenarios, including remote storage at a merchant (e.g., a card-on-file database) for on-line transactions with the merchant, a secure storage element (“secure element”) or other local device storage (e.g., internal memory of any of a mobile device, the devices 102, 104, 106, the hub 112, and the client device 116) for a mobile/digital wallet transaction, and so on.

In an example embodiment, the merchant computer system 121 obtains the payment token from one of the devices 102, 104, 106, and the hub 112, and then submits the payment token through a payment network to the card network computer system 122 (e.g., Visa®, MasterCard®, American Express®, Discover®, Diners Club®, etc.). The card network computer system 122 detokenizes the payment token to obtain the PAN, i.e., replaces the payment token with its associated PAN value based on the payment token-to-PAN mapping information stored in a token database (sometimes referred as a “token vault”). The card network computer system 122 then transmits the PAN to the card issuer (e.g., the FI computing system 120) for processing in a manner similar to a traditional credit card transaction. For example, the card issuer may approve the transaction, in which case the transaction with the merchant is completed and payment to the merchant is made. The token database may also maintain other information that may be used to apply restrictions or other controls during transaction processing.

In example embodiments, processing payment transactions using such payment tokens provides enhanced security in connection with payment card transactions. The payment tokens may be limited to use, e.g., only in connection with a specific merchant or a specific channel (e.g., payment via a specific mobile wallet). For example, in the event of a data breach at a merchant, the risk of subsequent fraud is reduced because only the payment tokens are exposed instead of PANs. In this example, the payment tokens are merchant-specific and therefore cannot be used at other merchants. Although the examples provided herein relate primarily to the use of payment tokens (which may be used to originate payment transactions), the systems and methods described herein may also be used with and non-payment tokens (e.g., customer loyalty tracking tokens, device identification tokens, etc.).

Turning to FIG. 2, block diagrams of the client device 116 and the device payment system 118 of FIG. 1 are illustrated. The client device 116 may, for example, be a cellular phone, smart phone, tablet computer, laptop computer, desktop computer, a wearable computing device (e.g., a smartwatch, eyewear, etc.), portable gaming device, or other suitable device. The client device 116 includes network interface logic 124, a display device 126, and an input device 128. The network interface logic 124 may include, for example, program logic that connects the client device 116 to each of the local network 108 and the external network 114. For example, the client device 116 may receive and display screens including device profiles, device restriction information, payment information, and so on. In one embodiment, a screen may be used to request a username and password information from the user, or to prompt the user to provide information regarding payment rules and limits for any of the devices 102, 104, 106, and the hub 112. Such screens are presented to the user via the display device 126. The input device 128 may be used to permit the user to initiate account access and to facilitate receiving requested information from the user. The input device 128 may include, for example, a keypad or keyboard, a touchscreen, a microphone, or any other device that allows the user to access the data processing system 100. As will be appreciated, in addition to or instead of the client device 116, users may also be provided with the ability to access the data processing system 100 using another type of computer (e.g., a desktop or laptop computer executing browser software) to perform the operations described herein as being performed by the client device 116.

The device payment system 118 includes a system configuration database 132, network interface logic 134, device binding logic 136, device authentication and attestation logic 138, and payment logic 140. The device payment system 118 is configured to store information regarding device payment system configurations in the system configuration database 132. By way of example, information for a specific system configuration 142 is shown as being stored in the system configuration database 132. As will be appreciated, the system configuration database 132 may also store information regarding many other system configurations (not shown), e.g., for other users. According to various example embodiments, information relating to the system configuration 142 is stored in whole or in part within the FI computer system 120. In other embodiments, information relating to the system configuration 142 is stored in whole or in part within the hub 112. In further embodiments, information relating to the system configuration 142 is stored in whole or in part within any of the devices 102, 104, 106. In certain situations, it may be desirable to store information relating to the system configuration 142 within the FI computer system 120 rather than within any of the devices 102, 104, 106, and the hub 112, because the FI computer system 120 may be capable of providing enhanced security functionality to protect the information from being stolen by fraudsters. In various embodiments, any of the information related to the system configuration 142 may be stored in a cloud-based storage system.

The system configuration 142 includes device profiles 144 for each of the devices 102, 104, 106, as well as a system profile 146, a customer identifier 148, and payment credentials 150. In an example embodiment, the system configuration 142 may be accessed and controlled by a user, for example, via the device payment app 130 on the client device 116, via a web-based interface, or via another type of application or interface. For example, users may add or remove devices, change device-level spending controls, change global spending controls, change user permissions and user-level spending controls, add or remove payment credentials 150 for payment accounts, etc. Accordingly, in example embodiments, users have complete control over their system configuration 142.

The device profiles 144 define operational parameters for each of the devices 102, 104, 106 in the local network 108. Each of the device profiles 144 may include a device identifier and spending controls for the corresponding device 102, 104, 106. For example, the first device 102 has a first device identifier and the second device 104 has a different second device identifier. The device identifier may include unique identifying characteristics (e.g., numbers, letters, or a combination thereof). Unique identifying characteristics may include, for example, Internet protocol version 6 (IPV6) address, Bluetooth Device Address (BDA), electronic serial number (ESN), international mobile equipment identity (IMEI) number, mobile equipment identifier (MEID), globally unique identifier (GUID), media access control (MAC) address, Ethernet address, phone number, etc. The device identifier may be inherent to the device or may be assigned to the device by the device payment system 118. In some embodiments, the device identifier may include a device identification token. According to an embodiment, the device identification token is a non-sensitive reference that substitutes and maps back to another identifying characteristic of the device. For example, the device identification token may include a portion of a device identifying characteristic (e.g., IPV6 address, BDA, etc.), with the remainder of the device identifying characteristic being replaced by random or pseudo-random values.

The device identifier of the first device 102, for example, may be communicated between the first device 102 and the device payment system 118 during a registration process. According to an example embodiment, operative communication is established between the device payment system 118 and the first device 102 (e.g., either directly or via operative communication with the hub 112) during the registration process. Upon establishing operative communication, the first device 102 transmits its device identifier to the device payment system 118. The device payment system 118 stores the device identifier in the system configuration 142. In another example embodiment, upon establishing operative communication, the device payment system 118 generates a device identification token for the first device 102, and transmits the device identification token to the first device 102. The device identification token may be stored in memory on the first device 102, and a matching device identification token may be stored in memory on the device payment system 118 (e.g., in the system configuration database 132). The device identification token uniquely identifies the first device 102 in the device payment system 118.

The device profiles 144 may also define device-level spending controls and limits for the respective devices 102, 104, 106. For example, device-level spending controls may define whether a respective device is eligible to make payments, as well as defining transaction amount limits, transaction frequency limits, overall device spending limits, approval requirements, etc., for each of the devices 102, 104, 106. Certain devices may be preconfigured with default spending controls. For example, all light bulbs may be preconfigured with a profile that defines that payments made by any light bulb must first be approved by the user. In some embodiments, the spending controls may be modified by the user, e.g., via the device payment app 130.

The system profile 146 defines spending controls and operational parameters for all of the devices in the local network 108. For example, system-level or global spending controls may define overall transaction amount limits, transaction frequency limits, overall system spending limits, approval requirements, order parameters, merchant preferences, notification preferences, etc., for all of the devices in the local network 108. For example, the system-level spending controls may define that all of the devices 102, 104, 106 may spend up to a total of $500 per month. In another example, an order parameter defined by the system-level spending controls may specify that replacement light bulbs must be ordered in groups of three because they are sold in groups of three by a merchant. Merchant preferences may specify whether replacement devices are to be ordered from the manufacturer or from a particular merchant. Notification preferences may define that certain devices are eligible to receive alerts (e.g., reorder alerts may be sent only to the television in the user's bedroom).

User profiles 148 define operational parameters and spending controls for each of the users of the device payment system 118. For example, multiple users (e.g., family members) may each have user profiles with the device payment system 118. Each of the user profiles 148 may have different permissions. For example, an administrative user (e.g., a head of household) may have full access to the system configuration and other users (e.g., children) may have limited access to the system configuration. For example, in an embodiment, only administrative users are allowed to configure spending controls. In another example, an administrative user must approve a payment request before the payment request is fulfilled. In a further example, only certain users receive notifications of certain types of device activities, such as payments. The system configuration 142 may also manage guest users. For example, a guest user may be able to use the system, but not to facilitate payments from their devices.

User-level spending controls define the parameters by which different users associated with the system configuration 142 are permitted or restricted regarding to their ability to make payments from the devices 102, 104, 106. The user-level spending controls may be global, across all of the devices 102, 104, 106 in the local network 108, or may be specific to each of the devices 102, 104, 106 in the local network 108. The user-level spending controls may be similar in nature to the device-level spending controls. For example, particular users may have payment eligibility limitations, as well as transaction amount limits, transaction frequency limits, overall device spending limits, approval requirements, etc. Device-level spending controls may also specify daily spending limits, monthly spending limits, spending velocity limits, etc., for each user, globally or per device. For example, the first device 102 may be a gaming system. An administrator-level user (e.g., a parent) may define that another user (e.g., a child) may spend up to a certain amount over a particular time period (e.g., up to $10/month) on payments from the gaming system. The administrator-level user may also define that the user may spend up to a different amount over a particular time period (e.g., up to $30/month) on payments from a different device, such as reordering snacks from the refrigerator. In some embodiments, an administer-level user may be prompted to approve certain transactions. For example, the administer-level user may receive a notification or text message that a user exceeded his or her monthly limits. Accordingly, the administer-level user may respond to the notification or text message to approve additional payments.

In some embodiments, the system configuration 142 may also include payment credentials 150. Payment credentials 150 may include credentials necessary to transfer payments from any of various financial accounts, such as credit card accounts, debit card accounts, business or consumer demand deposit accounts, lines of credit, gift cards, etc. The payment credentials 150 may be represented in various ways. For example, in one embodiment, the payment credentials 150 include a tokenized card number (TCN). According to various example embodiments, one or more payment tokens are provisioned by the FI computer system 120. The payment tokens may be provisioned to the hub 112 or to the devices 102, 104, 106. In some embodiments, the payment tokens include disposable (e.g., limited use or single use) payment tokens. For example, in one example embodiment, a payment token (e.g., a TCN or a tokenized PAN) is stored on the hub 112 upon the hub 112 being registered with the device payment system 118. The hub 112 may periodically retrieve fresh disposable keys from the FI computer system 120 or from another keymaster or token service provider.

The device binding logic 136 is configured to manage the binding and registration (e.g., pairing) of devices with the device payment system 118. Upon binding a device with the device payment system 118, a device profile 144 is created for the corresponding device. In one embodiment, a device, such as any of the devices 102, 104, 106, is bound or paired with the hub 112. Device binding may be manual or automatic. For example, in one embodiment, the first device 102 may be bound with the hub 112 by placing the first device 102 within close proximity of the hub 112 and pressing a particular button on the hub 112. The hub 112 may then recognize that the first device 102 is not already paired with the hub 112, and may proceed to bind the first device 102 with the hub 112. Device binding may include transmitting data (e.g., between the first device 102 and the hub 112) using various communication technologies, such as Bluetooth, low energy Bluetooth, NFC, wireless, optical image methods (e.g., QR code), RFID, hypersonic, Wi-Fi, cellular 3G, 4G, GSM, LiFi, etc. During the device binding process, a device identifier or a device identification token may be transmitted to the device being bound. The device identifier or device identification token may be generated locally (e.g., by the hub 112) or remotely (e.g., by a cloud-based system).

Device binding may also include configuring the device profile 144 of the corresponding device. As mentioned above, the device profile 144 may include spending controls for the respective devices 102, 104, 106, for example. For example, the spending controls may define whether a respective device is eligible to make payments, as well as transaction amount limits, transaction frequency limits, overall device spending limits, approval requirements, etc. Certain devices may be preconfigured with default spending controls.

The device authentication and attestation logic 138 is structured to control access to the local network 108. For example, device authentication and attestation may involve determining that a device is the device that it purports to be and represents what it purports to represent, and is not an imposter device. Device authentication and attestation may also involve verifying that the spending controls (e.g., as specified in the device profile 144) permit activities (e.g., payments) attempted by the device. In one embodiment, the device authentication and attestation logic 138 authenticates and attests the device by verifying that the device identifier (e.g., device identification token) stored on the device matches the corresponding device identifier stored in the device profile 144.

The device authentication and attestation logic 138 provides security functionality for the local network 108. For example, the device authentication and attestation logic 138 operates to prevent intruder devices—devices that are not registered with and bound to the system—from performing fraudulent transactions. For example, it would be undesirable for a third-party (e.g., not a member of the family that resides in the connected home 110) to bring a device into the connected home 110, whereupon the third-party device performs transactions via the device payment system 118 (e.g., ordering a replacement for itself, and sending the replacement to the owner's house). The device authentication and attestation logic 138 is configured to prevent such events. The device authentication and attestation logic 138 may also be configured to prevent a man-in-the-middle attack on the device payment system 118.

The payment logic 140 is structured to facilitate payments initiated by one of the devices 102, 104, 106, and the hub 112. The payment logic 140 may utilize various payment mechanisms, such open loop payments, closed loop payments, math-based currency payments, or any other payment mechanism. The payment logic may also facilitate various payment routing mechanisms. For example, in one embodiment, one of the devices 102, 104, 106, and the hub 112 may place orders directly with a merchant, via the payment logic 140. In some embodiments, the device payment system 118 provides an application programming interface (API) to vendors to facilitate automatic ordering and re-ordering.

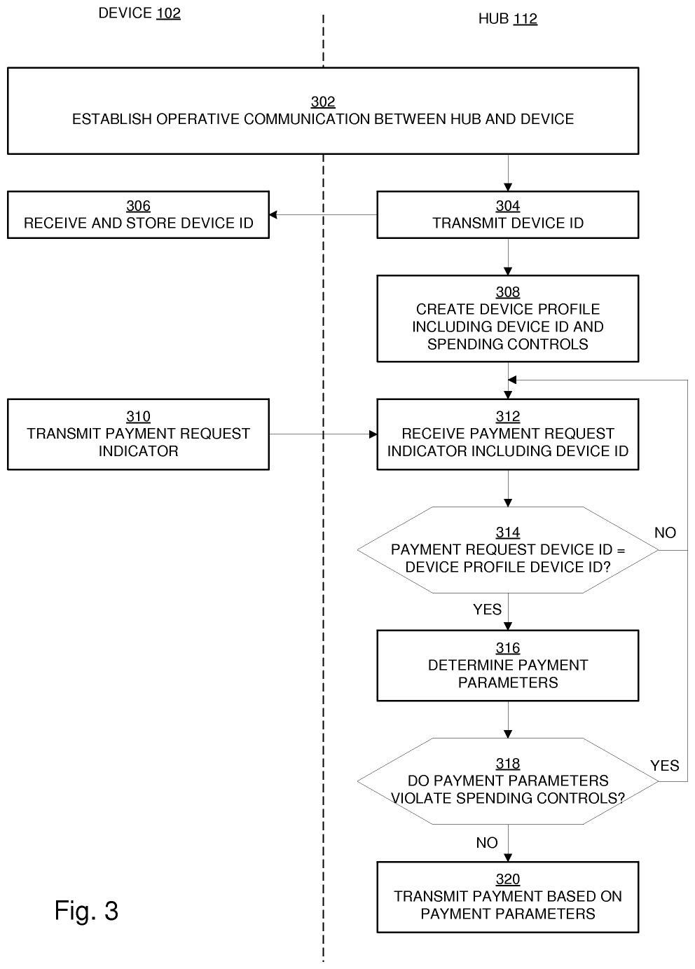

Turning to FIG. 3, a flow diagram of a method 300 of facilitating payments from a device, such as any of the devices 102, 104, 106 of FIG. 1, according to an embodiment. In one embodiment, the method 300 is performed by the hub 112 of FIG. 1, via operative communication with the device payment system 118 over the local network 108. As previously mentioned, the device payment system 118 may be implemented in whole or in part by the hub 112. For example, in one embodiment, the entire device payment system 118 is implemented by the hub 112. In this embodiment, the system configuration database 132 is stored in memory on the hub 112. In another embodiment, the entire device payment system 118 except for the system configuration database 132 is implemented by the hub 112. In this embodiment, the system configuration database 132 may be stored in a cloud-based system. For illustrative purposes, the method 300 will be described with respect to the first device 102 and the hub 112. It should be noted that in alternative embodiments, the method 300 may be performed by the device payment system 118 in operative communication with the first device 102 over the external network 114, without the use of the hub 112.

Steps 302-308 relate to binding the first device 102 to the device payment system 118 via the hub 112. The hub 112 may have already been bound to the payment account. At 302, operative communication is established between the hub 112 and the first device 102. Operative communication may be established between the hub 112 and the first device 102 in various ways. For example, operative communication may be established between the hub 112 and the first device 102 when a “pairing” button is depressed on the hub 112. In another example, the hub 112 may automatically communicate with the first device 102 upon the first device 102 being within a certain proximity of the hub 112. In an alternative embodiment, the first device 102 is bound to the device payment system 118 without use of the hub 112. In such an embodiment, the first device 102 may be a “smart” device that is capable of directly interfacing with the device payment system 118 via the external network 114.

At 304, a device identifier is communicated between the hub 112 and the first device 102. The device identifier uniquely identifies the first device 102 in the device payment system 118. At 306, the first device 102 records the device identifier in a device profile. In one embodiment, the device identifier is a device identification token.

At 308, a device profile is created for the first device 102. The device profile includes spending controls for the first device 102. The device profile also includes a duplicate device identifier that matches the device identifier transmitted to the first device 102. The device profile is stored in a database of the payment system. For example, as previously mentioned, the device profile may be stored locally on the hub 112 or remotely on a cloud-based storage system. In one embodiment, the payment profile is editable by a user via a device payment application.

At 310, a payment request is transferred from the first device 102. At 312, the payment request is received by the hub 112. The payment request includes a payment request indicator and the device identifier. The payment request indicator may include various types of information depending on the level of functionality that is implemented on the first device 102 and the hub 112. For example, in an embodiment in which the first device 102 is “smart,” the payment request indicator may include a request to purchase a specific product from a specific merchant. In another embodiment in which the first device 102 is “constrained,” the payment request indicator may include an operational value, such as a simple “ON” or “OFF” signal. For example, the first device 102 may be a light bulb and the hub 112 may be configured to monitor operation time of the light bulb. If the light bulb is rated for 10,000 hours, the hub 112 may order a replacement light bulb after 9,950 hours of use. In other embodiments, the first device 102 may sense that a component (e.g., on the first device 102 or on other devices within the local network 108) is non-functional or requires replacement, and the payment request indicator may include a message to that effect. In a further embodiment, the hub 112 may sense that one of the devices 102, 104, 106 within the local network 108 is non-functional or requires replacement.

At 314, it is determined whether the device identifier received with the payment request matches the duplicate device identifier stored in the device profile. If the answer to 314 is yes, the first device 102 is authenticated with the device payment system 118. If the answer to 314 is no, the first device 102 is authenticated and the payment request is ignored. This step ensures that only devices that are registered with the device payment system 118 may make payments through the system. To this effect, guest devices are prevented from making fraudulent payments through the device payment system 118.

At 316, upon the first device 102 being authenticated with the device payment system 118, payment parameters are determined based on the payment request indicator. In embodiments in which the first device 102 is “smart,” the payment parameters may be included in the payment request indicator. However, in embodiments in which the first device 102 is “constrained,” the hub 112 or the device payment system 118 may utilize logic to determine the payment parameters based on the received payment request indicator. For example, in the light bulb example noted above, payment request indicator may be an operational value of the light bulb, and the hub 112 may be configured to log the operation time of the light bulb, and generate payment parameters to order a replacement light bulb if the light bulb burns out or nears the end of its useful life.

At 318, it is determined whether the payment parameters violate the spending controls specified in the device profile 144. If the answer to 318 is yes, the payment request is denied. If the answer to 318 is no, the payment request is approved. As noted, the spending controls may be editable by a user via a device payment application. For example, the spending controls may define whether a respective device is eligible to make payments, as well as transaction amount limits, transaction frequency limits, overall device spending limits, approval requirements, etc.

At 320, upon approving the payment request, a payment is transmitted to a recipient based on the payment parameters. For example, the payment parameters may specify a particular product to be purchased from a particular merchant. Accordingly, the recipient would be the particular merchant from which the product is purchased. In some embodiments, the device payment system 118 provides an API to merchants to facilitate automatic ordering and re-ordering.

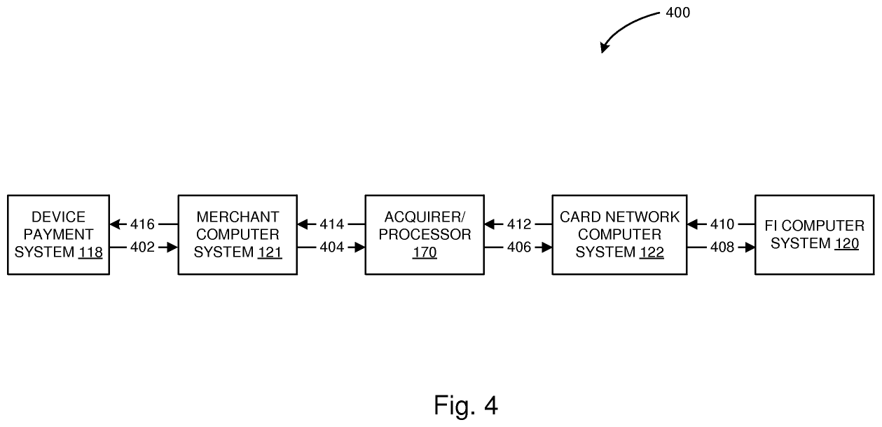

FIG. 4 illustrates a process 400 that may be implemented by the system 100 of FIGS. 1-2. By way of example, FIG. 4 shows a transaction initiated by device payment system 118, in operative communication with the first device 102. In one example embodiment, the transaction may be initiated by the device payment system 118 in response to an operational parameter received from the first device 102 (e.g., the parameter may indicate that the first device 102 needs to be replaced). The device payment system 118 may generate a payment request based on the operational parameter. In another example embodiment, the first device 102 may itself generate a payment request.

At step 402, the device payment system 118 may transmit a payment token to a merchant computer system 121 (e.g., using a QR code, NFC, wireless, Bluetooth, low energy Bluetooth, RFID, hypersonic, Wi-Fi, cellular 3G, 4G, GSM, LiFi, or other method). In some embodiments, the payment token is provisioned to the device payment system 118 or to the first device 102 in advance and is reused for many device payment transactions. In other embodiments, the payment token is dynamically provisioned to the device payment system 118 or to the first device 102.

At step 404, after receiving the payment token, the merchant computer system 121 sends the transaction to an acquirer processor computer system 170 for processing. Next, at step 406, the acquirer processor computer system 170 sends the payment token to the card network computer system 122 for processing a payment. The card network computer system 122 detokenizes the payment token, thereby resulting in the actual card number (PAN). At step 408, the card network computer system 122 sends the PAN to the FI computer system 120. The FI computer 120 then processes the transaction, for example, by approving the transaction based on the account status of the user (e.g., by confirming that the user has not exceed the credit limit of their credit card). The FI computer system 120 may then send an approval to the merchant computer system 121 via the card network computer system 122, the acquirer processor 170 (steps 410-121), and the payment to the merchant is made. Upon receiving the approval message the merchant computer system 121 may generate a receipt for the user. In some embodiments, the receipt may be sent to the device payment system 118 electronically.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A computer-implemented method of facilitating payments from a device, the method comprising:
providing, by a device payment computer system, an application that is installed on a hub that is connected to a local network and the device;
generating, by the device payment computer system, a device token regarding the device that is a non-sensitive value identifying the device;
storing, by the device payment computer system, the device token;
transmitting, by the device payment computer system, a matching device token to the device for storage based on the stored device token;
binding, by the device payment computer system, the device with the device payment computer system by:
establishing operative communication between the hub via the installed application and the device,
creating a device profile for the device, the device profile being tied to the device token, the device profile further defining an operation parameter for the device,
providing a client application to a client device,
receiving a spending control specific to the device from the client application of the client device, wherein the spending control prevents the device from making a payment when a predetermined limit is exceeded, the predetermined limit defining a transaction amount limit, a transaction frequency limit, and an overall spending limit, and
storing the device profile in a database of the device payment computer system;
provisioning, by the device payment computer system, a payment token to the hub, the payment token associated with a payment card;
receiving, by the device payment computer system, a current operation parameter and the matching device token from the device via the hub, wherein the current operation parameter includes at least one of a voltage, current, temperature, acceleration, position, operation time, or functional status of the device;
authenticating, by the device payment computer system, the device in response to determining that the matching device token received with the current operation parameter matches the device token tied to the device profile;
accessing, by the device payment computer system, the device profile from the database based on authenticating the matching device token;
logging, by the device payment system, the current operation parameter to an operation parameter log stored in the device profile that includes previous operation parameters received from the device;
determining, by the device payment computer system upon authenticating the device, payment parameters based on the operation parameter log, wherein the payment parameters indicate a particular product to be purchased as a replacement for a product associated with the device, and wherein determining the payment parameters comprises determining that the product associated with the device has been used for a pre-determined amount of time using the operation parameter log;
sensing, by the device payment computer system, that the device is nonfunctional based on the current operation parameter;
verifying, by the device payment computer system, that the payment parameters do not violate the spending controls stored in the device profile;
in response to verifying that the payment parameters do not violate the spending controls, providing, by the device payment computer system to the client device, a user interface that prompts a user to approve a payment for the particular product based on sensing that the device is nonfunctional or that the device has been used for the pre-determined amount of time;
receiving, by the device payment computer system from the client device, an input from the user approving the payment;
in response to receiving the input from the user approving the payment, instructing, by the device payment computer system, the hub to send the payment token to a merchant computer system; and
receiving, by the device payment computer system, the payment token from the merchant computer system to process the payment for the particular product.

2. (canceled)

3. The method of claim 1, wherein the device token is transmitted from the hub to the device.

4. The method of claim 1, wherein the device is a first device, and further comprising:
binding, by the device payment computer system, a second device with the device payment account;
establishing, by the device payment computer system, a system profile, the system profile including system-level spending controls relating to payments from each of the first and second devices; and
verifying, by the device payment computer system and prior to providing the user interface that prompts the user to approve the payment, that the payment parameters do not violate the system-level spending controls.

5. The method of claim 1, wherein the device profile is editable by a user via the client application.

6. (canceled)

7. The method of claim 1, further comprising preventing, by the device payment computer system, payments from being transmitted if the matching device token associated with the current operation parameter does not match the device token stored in the device profile.

8. A system, comprising:
a server system, the server system comprising a processor and instructions stored in non-transitory machine-readable media, the instructions configured to cause the server system to:
provide an application that is installed on a hub that is connected to a local network and the device;
generate a device token regarding a device that is a non-sensitive value identifying the device;
store the device token;
transmit a matching device token to the device for storage based on the stored device token;
bind a device with the server system by causing the server system to:
establish operative communication between the device and the hub via the installed application,
create a device profile for the device, the device profile being tied to the device token, and the device profile further defining an operation parameter for the device,
provide a client application to a client device;
receive a spending control specific to the device from the client application of the client device, wherein the spending control prevents the device from making a payment when a predetermined limit is exceeded, the predetermined limit defining at least one of a transaction amount limit, a transaction frequency limit, and an overall spending limit, and
store the device profile in a database of the server system;
provision a payment token to the hub, the payment token associated with a payment card;
receive a current operation parameter and the matching device token from the device via the hub, wherein the current operation parameter includes at least one of a voltage, current, temperature, acceleration, position, operation time, or functional status of the device;
authenticate the device in response to determining that the matching device token received with the current operation parameter matches the device token tied to the device profile;
access the device profile from the database based on authenticating the matching device token;
log the current operation parameter to an operation parameter log stored in the device profile that includes previous operation parameters received from the device;
determine, upon authenticating the device, payment parameters based on the operation parameter log, wherein the payment parameters indicate a particular product to be purchased as a replacement for a product associated with the device, and wherein to determine the payment parameters the instructions are configured to cause the server system to determine that the product associated with the device has been used for a pre-determined amount of time using the operation parameter log;
sense that the device is nonfunctional based on the current operation Parameter;
verify that the payment parameters do not violate the spending controls stored in the device profile;
in response to verifying that the parameters do not violate the spending controls, provide a user interface to the client device that prompts a user to approve a payment for the particular product based on sensing that the device is nonfunctional or that the device has been used for the pre-determined amount of time;
receive, from the client device, an input from the user approving the payment;
in response to receiving the input from the user approving the payment, instruct the hub to send the payment token to a merchant computer system; and
receive the payment token from the merchant computer system to process the payment for particular product.

9. (canceled)

10. The system of claim 8, wherein the device token is transmitted from the hub to the device.

11. The system of claim 8, wherein the device is a first device, and wherein the instructions are further configured to cause the server system to:
bind a second device with the device payment account;
establish a system profile, the system profile including system-level spending controls relating to payments from each of the first and second devices; and
verify, prior to providing the user interface to the client device, that the payment parameters do not violate the system-level spending controls.

12. The system of claim 8, wherein the device profile is editable by a user via the client application.

13. (canceled)

14. The system of claim 8, wherein the instructions are further configured to cause the server system to prevent payments from being transmitted if the matching device token associated with the current operation parameter does not match the device token identifier stored in the device profile.

15.-29. (canceled)
